(19) United States
(12) Patent Application Publication
(10) Pub. No.: US 2025/0212119 A1
(43) Pub. Date: Jun. 26, 2025

(54) SYSTEMS, METHODS, AND DEVICES FOR LOW-POWER WAKEUP OPERATIONS

(71) Applicant: Cypress Semiconductor Corporation, San Jose, CA (US)

(72) Inventors: Daniel Lee, Salt Lake City, UT (US); Ajinder Pal Singh, Allen, TX (US); Oleksandr Karpin, Lviv (UA)

(73) Assignee: Cypress Semiconductor Corporation, San Jose, CA (US)

(21) Appl. No.: 18/391,286

(22) Filed: Dec. 20, 2023

(51) Int. Cl. H04W 52/02

(52) U.S. Cl. CPC H04W 52/0229; H04W 52/0216

(57) ABSTRACT

Systems, methods, and devices provide low-power wakeup operations in wireless environments. Methods include receiving a signal at a wireless device, the signal comprising a data packet compatible with a wireless communication protocol, performing, using one or more processing elements, a first wake detection operation at a first wake stage of the wireless device, and determining, based on a designated pattern and performance parameters, if a second wake detection operation should be performed at a second wake stage of the wireless device. Methods also include determining, using one or more processing elements, if a valid wake code has been received based on a designated wake code associated with the data packet.

### TECHNICAL FIELD

This disclosure relates to wireless communications, and more specifically, to enhancement of wakeup operations implemented in wireless environments associated with such wireless communications.

### BACKGROUND

Wireless devices may be configured to communicate with each other via one or more wireless communication protocols. Accordingly, wireless connections may be established and used for such wireless communication. Moreover, such wireless device may be configured to operate in various different power consumption modes, such as a wake mode and a sleep mode, to improve power consumption efficiency in low-power operational contexts. Conventional techniques for implementing such power consumption modes remain limited because they often utilize additional hardware resources to manage transitions between modes, and can be inefficient even when in a sleep mode.

### BRIEF DESCRIPTION OF THE DRAWINGS

FIG. 1 illustrates an example of a system for low-power wakeup operations, configured in accordance with some embodiments.

FIG. 2 illustrates an example of a device for low-power wakeup operations, configured in accordance with some embodiments.

FIG. 3 illustrates an example of a processing device for low-power wakeup operations, configured in accordance with some embodiments.

FIG. 4 illustrates an example of wake stages used for low-power wakeup operations, configured in accordance with some embodiments.

FIG. 5 illustrates an example of a wake signal detector, configured in accordance with some embodiments.

FIG. 6 illustrates flow chart of an example of a method for low-power wakeup operations, performed in accordance with some embodiments.

FIG. 7 illustrates flow chart of another example of a method for low-power wakeup operations, performed in accordance with some embodiments.

FIG. 8 illustrates flow chart of an additional example of a method for low-power wakeup operations, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may be configured to operate in different power consumption modes to improve overall power efficiency by reducing overall power consumption of components when not in use. For example, wireless devices may have a sleep mode and a wake mode where each respective mode has a defined scheme identifying which power domains of the wireless device are powered and which power domains are unpowered. For example, in a wake mode, all power domains of the wireless device may be powered, and in a sleep mode various power domains, such as a main processor core and memory, may be depowered, while one or more power domains, such as one or more components of a transceiver, remain powered. Conventional techniques for implementing such sleep modes remain limited because they rely on implementation of additional hardware resources, such as gain stages and data converters, for transitioning from a sleep mode to a wake mode. Such additional hardware resources consume additional power, even when a wireless device is in sleep mode.

Embodiments disclosed herein provide low-power implementations for wakeup operations in wireless devices. As will be discussed in greater detail below, front-end logic is configured to split and manage wakeup operations among multiple different wake stages. Such wake stages may be configured such that low-power components are used for wake operations, and usage of an additional wake stage occurs dynamically in response to designated operational conditions, such as when the initial wake stage is unavailable or experiencing interference. In this way, a configuration of a usage of components underlying wakeup determinations is determined dynamically, and overall power efficiency of the front-end logic is improved.

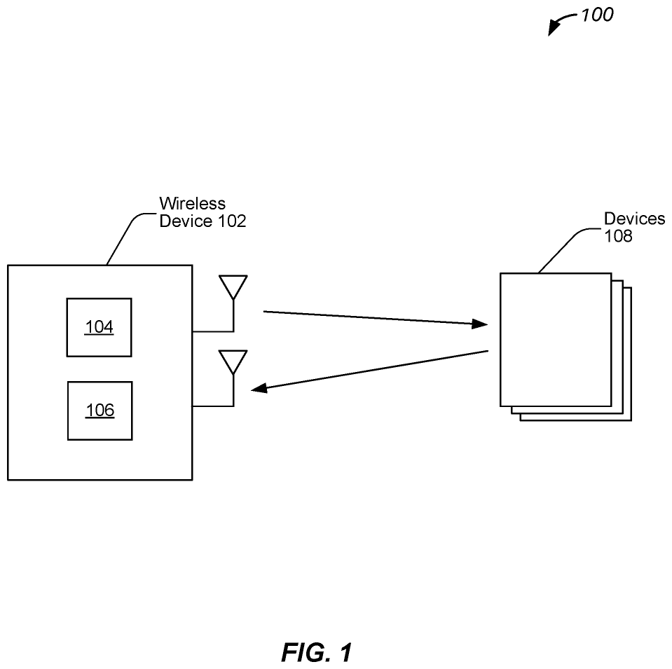

FIG. 1 illustrates an example of a system for low-power wakeup operations, configured in accordance with some embodiments. Accordingly, a system, such as system 100, may include wireless devices that are used for wireless communications, and are also configured to perform low-power wakeup operations as disclosed herein. Accordingly, as will be discussed in greater detail below, wireless devices included in system 100 may be configured to include multiple wake stages for wakeup operations that improve the efficiency of the implementation of such wakeup operations and the management of their associated power domains.

In various embodiments, system 100 may include wireless device 102 which may be a wireless communications device. As discussed above, such wireless devices may be compatible with one or more wireless transmission protocols, such as a Bluetooth protocol. Accordingly, wireless device 102 includes a transceiver, such as transceiver 104, that is compatible with a Bluetooth specification and protocol. For example, the Bluetooth protocol may be a Bluetooth Low Energy (BLE) protocol. It will be appreciated that while embodiments disclosed herein describe a Bluetooth protocol, any suitable communications protocol and communications medium may be used. As disclosed herein a transceiver may have associated transmit and receive chains and processing logic. As will be discussed in greater detail below, such processing devices and transceivers may be configured to establish communications connections with other devices and transmit data in the form of data packets via such communications connections.

In some embodiments, wireless device 102 may be low-power device configured to operate in accordance with one or more power parameters and/or constraints. Moreover, wireless device 102 may be configured to support various operational modes having different power consumption characteristics, such as a wake mode and a sleep mode which may each have different configurations of powered and unpowered power domains within wireless device 102. In some embodiments, wireless device 102 may be a smart device, such as those found in wearable devices, or may be a monitoring device, such as those found in smart buildings, environmental monitoring, and energy management, as well as security systems, such as that found in a smart home lock. It will be appreciated that such wireless devices may be any suitable device, such as those found in cars, other vehicles, and even medical implants.

As shown in FIG. 1, various wireless communications devices may be in communication with each other via one or more wireless communications mediums. Moreover, wireless device 102 may include one or more antennas, and may also include processing device 106. As will be discussed in greater detail below, processing device 106 may be configured to manage wakeup operations for various components of wireless device 102. More specifically, processing device 106 may include multiple wake stages that may detect an input and transition one or more other components, such as processing logic or one or more processor cores, from a sleep mode to a wake mode in response to identifying the input. As will also be discussed in greater detail below, the multiple wake stages may be managed such that a low-power stage is used to reduce power consumption associated with wakeup operations, and an additional stage is used dynamically and in response to particular operational conditions. In this way, additional power consumption of the additional stage is reduced, and overall power consumption of wireless device 102 is reduced during wakeup operations.

In some embodiments, system 100 may further include devices 108 which may also be wireless devices. As similarly discussed above, devices 108 may be compatible with one or more wireless transmission protocols, such as a Wi-Fi protocol or a Bluetooth protocol. For example, devices 108 may be smart devices or other devices, such as audio devices, gaming systems, cars, other vehicles, and medical implants. In various embodiments, devices 108 may be different types of devices than wireless device 102. As discussed above, each of devices 108 may include one or more antennas, as well as processing devices and transceivers, which may also be configured to establish communications connections with other devices, and transmit data in the form of data packets via such communications connections. Accordingly, as will be discussed in greater detail below, an input received at wireless device 102 to trigger a wakeup operation may be received from devices 108.

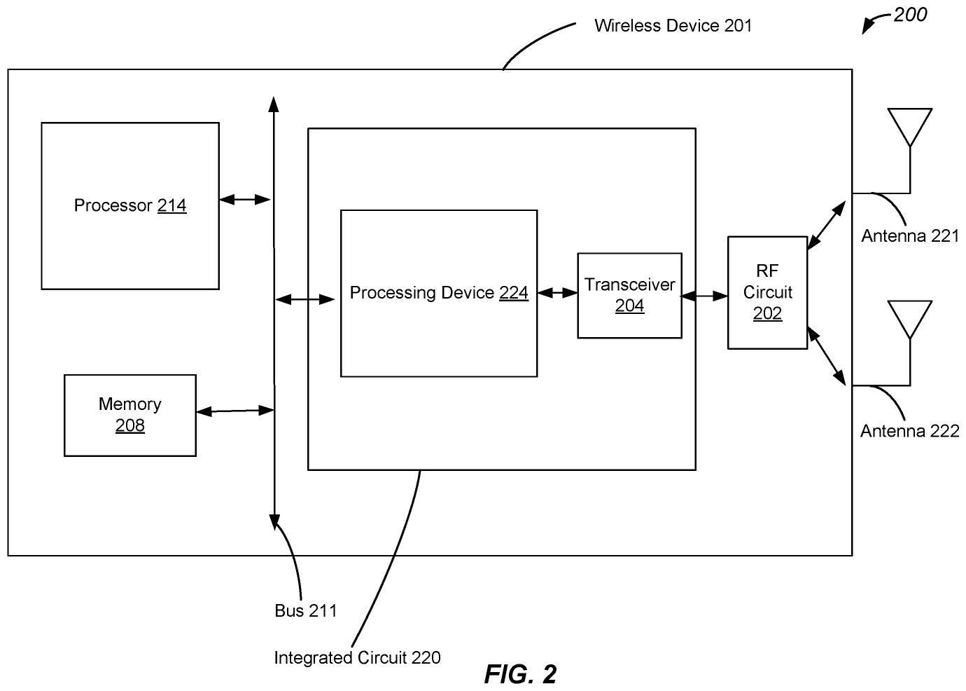

FIG. 2 illustrates an example of a device for low-power wakeup operations, configured in accordance with some embodiments. More specifically, FIG. 2 illustrates an example of a system, such as system 200, that may include wireless device 201. It will be appreciated that wireless device 201 may be one of the wireless devices discussed above with reference to FIG. 1, such as wireless device 102.

In various embodiments, wireless device 201 includes one or more transceivers, such as transceiver 204. In one example, system 200 includes transceiver 204 which is configured to transmit and receive signals using a communications medium that may include antenna 221 or antenna 222. As noted above, transceiver 204 may be a Bluetooth transceiver. Accordingly, transceiver 204 may be compatible with a Bluetooth communications protocol, which may be a Bluetooth Low Energy (BLE) protocol. Moreover, transceiver 204 includes a modulator and demodulator as well as one or more buffers and filters, which are configured to generate and receive signals via antenna 221 and/or antenna 222. While various embodiments are described with reference to a Bluetooth communications protocol, it will be appreciated that any suitable protocol may be used.

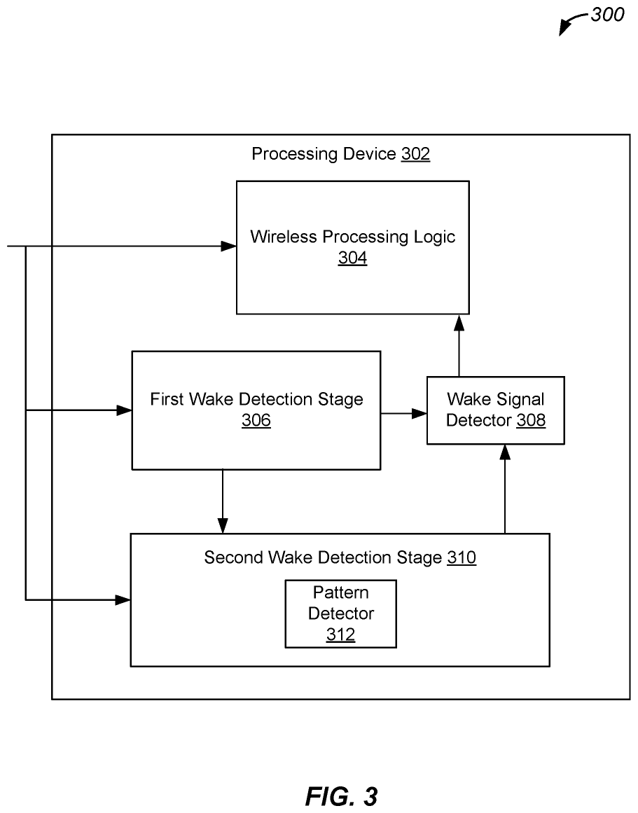

In various embodiments, system 200 further includes one or more processing devices, such as processing device 224 which may include logic implemented using processing elements that may be included in one or more processor cores. Accordingly, processing device 224 is configured to implement logic for low-power wakeup operations, as will be discussed in greater detail below. In some embodiments, processing device 224 is configured to implement a wakeup front-end used to perform determination operations for wakeup operations. More specifically, the wakeup front-end may remain powered, even during a sleep mode, and may receive and process inputs to identify a wake signal and determine if other components of wireless device 201 or system 200 should be transitioned to a wake mode. As will be discussed in greater detail below with reference to FIG. 3, the wakeup front-end may have different stages that also have different power consumption parameters. Thus, as disclosed herein, management and usage of such different stages provides improved efficiency of implementation of wakeup operations.

In various embodiments, processing device 224 additionally includes processing elements configured to implement one or more layers underlying the previously discussed communications protocols. For example, processing device 224 may be configured to implement the Bluetooth protocol for transceiver 204. For example, processing device 224 may include processing elements configured to implement the Bluetooth protocol via a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers.

System 200 further includes radio frequency (RF) circuit 202 which is coupled to antenna 221 and antenna 222. In various embodiments, RF circuit 202 may include various components such as an RF switch, a diplexer, and a filter. Accordingly, RF circuit 202 may be configured to select an antenna for transmission/reception, and may be configured to provide coupling between the selected antenna, such as antenna 221 or antenna 222, and other components of system 200 via a bus, such as bus 211. While one RF circuit is shown, it will be appreciated that wireless device 201 may include multiple RF circuits. Accordingly, each of multiple antennas may have its own RF circuit.

System 200 includes memory system 208 which is configured to store one or more data values associated with wakeup operations discussed in greater detail below. Accordingly, memory system 208 includes storage device, which may be a non-volatile random-access memory (NVRAM) configured to store such data values. In various embodiments, system 200 further includes processor 214 which is configured to implement processing operations implemented by system 200. For example, processor 214 may be configured to perform processing operations for other applications supported by wireless device 201 and system 200 once wakeup operations have been performed.

It will be appreciated that one or more of the above-described components may be implemented on a single chip, or on different chips. For example, transceiver 204 and processing device 224 may be implemented on the same integrated circuit chip, such as integrated circuit chip 220. In another example transceiver 204 and processing device 224 may each be implemented on their own chip, and thus may be disposed separately as a multi-chip module or on a common substrate such as a printed circuit board (PCB).

FIG. 3 illustrates an example of a processing device for low-power wakeup operations, configured in accordance with some embodiments. As similarly discussed above, a processing device, such as processing device 302, may be configured to implement logic for low-power wakeup operations, and more specifically, may be configured to implement a wakeup front-end used to perform determination operations for wakeup operations. As also discussed above, processing device 302 may include wireless processing logic 304 used to implement components of a communications protocol, such as a Bluetooth stack.

In various embodiments, processing device 302 includes first wake detection stage 306 which is configured to monitor a received signal, and determine if a wake signal has been received. In various embodiments, the received signal may be received via a receive chain of a transceiver. Moreover, the received signal may include one or more data packets received from another wireless device via the communications medium of the transceiver.

In various embodiments, first wake detection stage 306 is configured to implement a wide-band signal detection technique. For example, first wake detection stage 306 may include an envelope detector that is configured to implement envelope detection or peak detection to identify the presence of an input signal that has been received. First wake detection stage 306 may also include one or more components, such as a voltage multiplier and low-pass filter that may perform such voltage multiplication and low-pass filtering on a received input signal in response to the envelope detector identifying a received input.

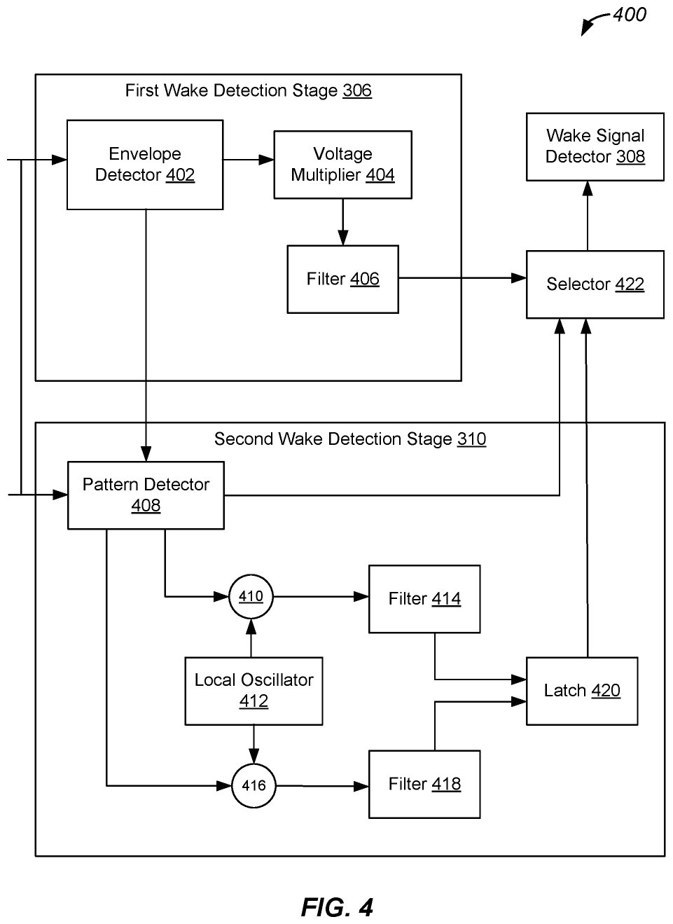

Processing device 302 additionally includes second detection stage 310 which is configured to determine if a wake signal has been received based on a narrow-band signal detection technique. For example, second detection stage 310 may be configured to use a frequency modulation-based detection technique. More specifically, second detection stage 310 may include a local oscillator, one or more mixers and band-pass filters and a latch that are configured to extract a data pattern from the received signal. Additional details regarding configuration of second detection stage 310 are discussed in greater detail with reference to FIG. 4.

In various embodiments, second detection stage 310 is configured to activate and operate in response to one or more operational parameters. For example, if a pattern of activity associated with first wake detection stage 306 is observed, second detection stage 310 may activate and be used for wake signal detection. For example, such a pattern of activity may be detected by pattern detector 312, and may include a designated pattern of outputs from a component of first wake detection stage 306, such as the envelope detector. In one example, the designated pattern may be a sequence of negative determinations or non-replies from the envelope detector. Such a sequence may have a designated length or number of periods determined by the designated pattern, and such a designated pattern may have been determined by an entity, such as a manufacturer. In some embodiments, such a designated pattern of activity of first wake detection stage 306 may occur when there is interference from another wireless device or the other wireless device is outside of a range suitable for wide-band techniques. Accordingly, second detection stage 310 may be activated and used in response to a dynamic determination that first wake detection stage 306 is experiencing operational conditions, such as interference. In various embodiments, the designated pattern may be a series of data values included in a beacon data packet. Thus, according to some embodiments, second detection stage 310 may be activated in response to one or more data values included in a header of a received data packet that specifies which detection stage should be used.

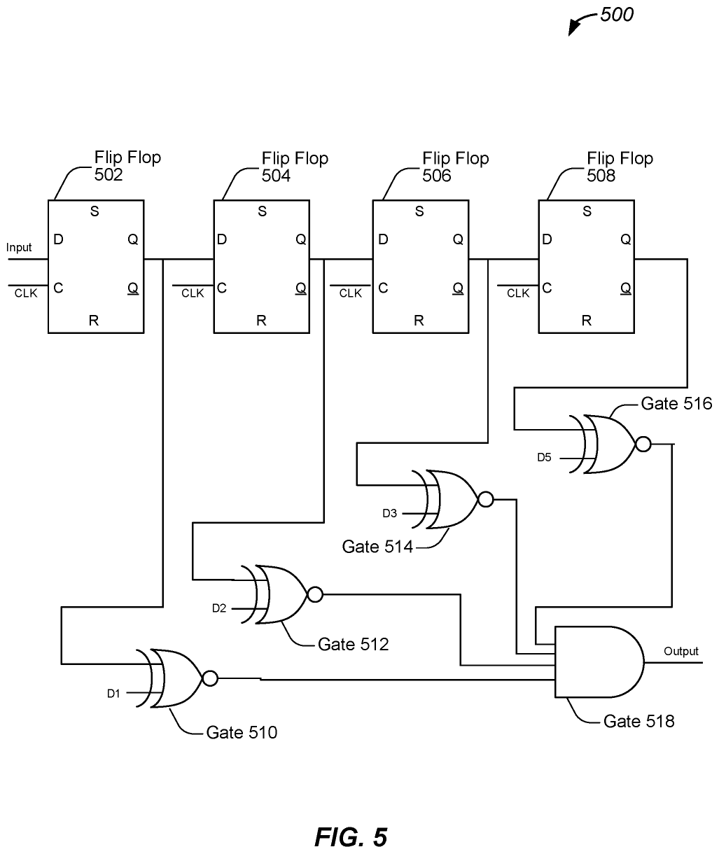

Outputs of first wake detection stage 306 and second detection stage 310 may be provided to wake signal detector 308 which is configured to take an output of either first wake detection stage 306 or second detection stage 310, and compare that against a stored set of data values to determine if a wake signal has been received. In one example, the data values may represent a wake sequence or a wake word. Thus, data values extracted by first wake detection stage 306 or second detection stage 310 may be compared against the stored data values to determine if a wireless device should be transitioned to a wake mode. For example, wake signal detector 308 may provide an output signal to wireless processing logic 304 that transitions wireless processing logic 304 to a wake mode in response to determining a valid wake signal has been received. Additional details regarding wake signal detector 308 are discussed in greater detail below with reference to FIG. 5.

FIG. 4 illustrates an example of wake stages used for low-power wakeup operations, configured in accordance with some embodiments. As similarly discussed above, processing elements used to manage and implement wake operations for a wireless device may be configured to include a multi-stage front-end that analyzes received signals, and determines when a wake operations should be performed, as may occur when a valid wake signal is received. Accordingly, as also discussed above, a processing device, such as processing device 400, may include first wake detection stage 306 and second detection stage 310.

In various embodiments, first wake detection stage 306 is configured to perform wide-band detection operations that may use, for example, an envelope detection-based technique. Accordingly, first wake detection stage 306 includes envelope detector 402 which is configured to perform envelope detection on a received signal that may be received via an antenna and transceiver. Accordingly, envelope detector 402 has a designated frequency band, and is configured to perform peak detection in a received signal. In various embodiments, envelope detector 402 may be configured to detect an initial portion of a header of a received data packet. In one example, a 2 byte header may trigger envelope detector 402, and a subsequent data payload included in the data packet may include a wake code. This code may then be provided to selector 422 discussed in greater detail below. It will be appreciated that any suitable type of envelope detector may be used. In various embodiments, first wake detection stage 306 additionally includes voltage multiplier 404 which is configured to apply a designated voltage gain based on a designated gain factor that may be set by, for example, a manufacturer or other entity. Moreover, first wake detection stage 306 also includes filter 406, which may be a low pass filter configured to filter and isolate components of the output of envelope detector 402 that are relevant for wake signal detection.

In various embodiments, an output of envelope detector 402 is also provided to second detection stage 310, and more specifically, to pattern detector 408 which is configured to detect a designated pattern of activity from envelope detector 402. As similarly discussed above, such a designated pattern of activity may be a lack of activity or no peak detection for a designated period of time. In another example, the designated pattern may be specified in a header of a data packet. In various embodiments, pattern detector 408 is additionally configured to power and de-power components of second detection stage 310 in response to a detection status associated with the designated pattern. In this way, pattern detector 408 determines when second detection stage 310 should be used, but also de-powers components of second detection stage 310 when not in use. For example, pattern detector 408 may include a pFET configured to be switched on in response to detecting the designated pattern, thus providing power to components of second detection stage 310, such as mixers, filters, and other components discussed below.

In response to identifying the designated pattern of activity, pattern detector 408 may pass the received signal, that may have been received via an antenna and transceiver, to mixer 410 and mixer 416, which may be coupled to local oscillator 412. In one example, local oscillator 412 is configured based on an operational frequency of the wireless communications medium and may, for example, be a 2.4 Ghz ring oscillator. Moreover, mixer 416 may be configured to operate with a 90 degree phase offset. Outputs of mixer 410 and mixer 416 may be fed to filter 414 and filter 418 which may be band-pass filters. In one example, the band-pass filters may be 250 KHz filters. It will be appreciated that the values of the filters may be configured based on a modulation frequency of a wireless communication protocol, and may be thus configured based on parameters set forth by a wireless standard. Outputs of filter 414 and filter 418 may be fed to latch 420. In one example, latch 420 is a D latch, and an output of filter 414 is provided as an input, and an output of filter 418 is provided as a clock signal. In some embodiments, second wake detection stage 310 converts the received signal to I-Q samples, and an output of latch 420 provides such samples as data values.

In various embodiments, outputs of filter 406 and latch 420 are provided to selector 422. Moreover, an output of pattern detector 408 is provided to selector 422 as well. The output of pattern detector 408 provides a control signal for selector 422. Accordingly, when pattern detector 408 has selected and activated components of second detection stage 310, it may also provide a control signal to selector 422 to configure it to receive and process an output of second detection stage 310. When second detection stage 310 is not in use, and first wake detection stage 306 is used, the control signal may instead select the output of first wake detection stage 306. In this way, pattern detector 408 may manage activation and usage of components of second detection stage 310, and also selection of which input is provided to wake signal detector 308.

FIG. 5 illustrates an example of a wake signal detector, configured in accordance with some embodiments. In various embodiments, a wake signal detector, such as wake signal detector 500, is implemented using combinatorial logic. Accordingly, such a wake signal detector may be implemented using low-power circuitry, and additional hardware resources are not needed.

As shown in FIG. 5, wake signal detector 500 includes a series of flip flops, such as flip flop 502, flip flop 504, flip flop 506, and flip flop 508. In various embodiments, outputs of the flip flops are provided to XNOR gates. For example, an output of flip flop 502 is provided to gate 510, an output of flip flop 504 is provided to gate 512, an output of flip flop 506 is provided to gate 514, and an output of flip flop 508 is provided to gate 516. Moreover, outputs of storage locations in memory, such as data values stored in memory registers may also be provided as inputs to the XNOR gates. As shown in FIG. 5, a sequence of data values may be provided that corresponds to a valid wake signal. Thus, according to some embodiments, the valid wake signal may be a four digit binary code, and the four digits may be provided as inputs to the XNOR gates.

Moreover, outputs of the XNOR gates are provided to an AND gate, such as gate 518. Accordingly, an input may be received, and the data values may be sequentially latched into the flip flops. When all digits match, and output of gate 518 may generate a signal that indicates that a match has occurred and a valid wake signal has been received. As shown in FIG. 5, the flip flops may also have a reset input that may be periodically triggered to reset wake signal detector 500 in preparation for a subsequent detection operation.

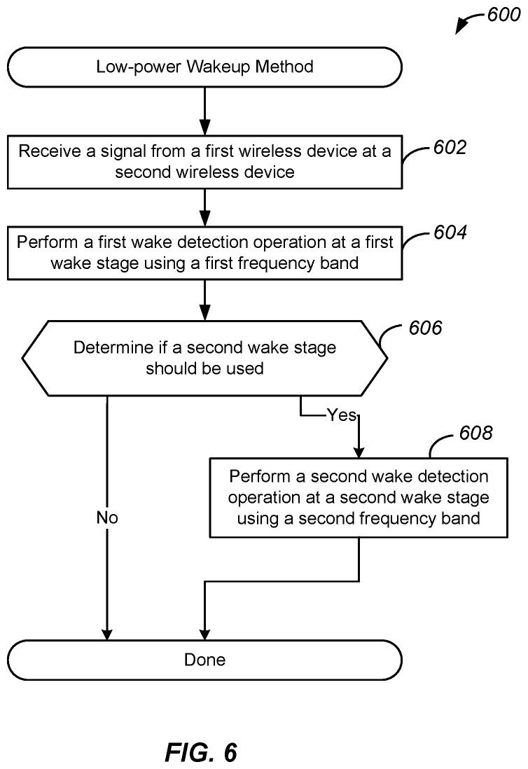

FIG. 6 illustrates flow chart of an example of a method for low-power wakeup operations, performed in accordance with some embodiments. As similarly discussed above, processing of a received signal may be split between multiple stages to improve overall power consumption and efficiency of a front-end used for such wake operations. Accordingly, a method, such as method 600, may be performed to determine which wake stage should be used for wakeup operations.

Method 600 may perform operation 602 during which a signal may be received from a first wireless device at a second wireless device. As similarly discussed above, the first wireless device and the second wireless device may communicate in accordance with a wireless communication protocol, such as a Bluetooth protocol. In various embodiments, the signal may include a beacon frame transmitted from the first wireless device to the second wireless device. Accordingly, at operation 602, the beacon frame may be received at the second wireless device.

Method 600 may perform operation 604 during which a first wake detection operation may be performed at a first wake stage using a first frequency band. As similarly discussed above, the first wake stage may be configured to perform wide-band signal detection using, for example, envelope detection. Accordingly, during operation 604, the received signal may be provided to components of the first wake stage, such as an envelope detector, a voltage multiplier, and a filter. Moreover, a first output signal may be generated based on an output of the filter. As discussed above, the first output signal may include an extracted wake code that may have been included in the beacon frame as a data payload.

Method 600 may perform operation 606 during which it may be determined if a second wake stage should be used for a wake operation. In various embodiments, such a determination may be made based on a determination of whether or not a designated pattern is present. As similarly discussed above, the designated pattern may be configured to identify situations and operational conditions in which the second wake stage should be used to augment decisions made by the first wake stage. For example, a designated pattern of activity may be identified that indicates that the first wake stage is experiencing interference, as may occur from unrelated activity of another wireless device. In response to identifying the designated pattern, the second wake stage may be activated, and the received signal may be provided to the second wake stage.

If it is determined that the second wake stage should be used, method 600 may perform operation 608 during which a second wake detection operation may be performed at the second wake stage using a second frequency band. Accordingly, as similarly discussed above, the second wake stage may be configured to perform narrow-band signal detection using a frequency modulation-based technique. Moreover, a second output signal may be generated based on an output of a component, such as a latch. As discussed above, the second output signal may include an extracted wake code that may have been included in the beacon frame as a data payload. Furthermore, if the second wake stage is used, the output of the second wake stage may be selected for verification of the wake code.

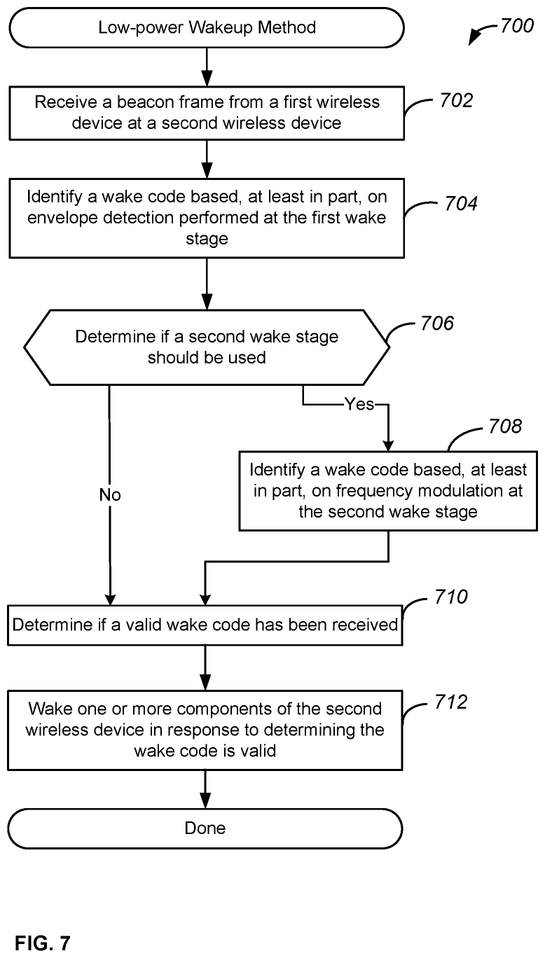

FIG. 7 illustrates flow chart of another example of a method for low-power wakeup operations, performed in accordance with some embodiments. As similarly discussed above, processing of a received signal may be split between multiple stages to improve overall power consumption and efficiency of a front-end used for such wake operations. Accordingly, a method, such as method 700, may be performed to determine which wake stage should be used for wakeup operations, such as verification of a received wake code.

Method 700 may perform operation 702 during which a beacon frame may be received from a first wireless device at a second wireless device. As similarly discussed above, the first wireless device and the second wireless device may communicate in accordance with a wireless communication protocol, such as a Bluetooth protocol. For example, the first wireless device may be a smart device, such as a smart phone. The second wireless device may be another smart device, such as a smart lock. Accordingly, the first wireless device may periodically transmit beacon frames to notify other devices of its existence. In various embodiments, the beacon frame may be configured to include a data unit that is configured to store data values representing a wake code. In one example, the data packet is a Bluetooth Low Energy data packet configured to store binary string representing the wake code.

Method 700 may perform operation 704 during which a wake code may be identified based, at least in part, on envelope detection performed at the first wake stage. As similarly discussed above, the first wake stage may be configured to perform wide-band signal detection using, for example, envelope detection. Accordingly, during operation 704, the received signal may be provided to components of the first wake stage, such as an envelope detector, a voltage multiplier, and a filter. Moreover, a first output signal may be generated based on an output of the filter. As discussed above, the first output signal may include an extracted wake code that may have been included in the beacon frame as a data payload. It will be appreciated that in some operational conditions, no wake code may be present. For example, a received data frame might not include a wake code, or interference may interfere with reception of the wake code. Accordingly, during operation 704, a wake code might not be identified, or a different sequence of data values may be obtained.

Method 700 may perform operation 706 during which it may be determined if a second wake stage should be used for a wake operation. As similarly discussed above, such a determination may be made based on a determination of whether or not a designated pattern is present. In various embodiments, the designated pattern may be configured to identify situations and operational conditions in which the second wake stage should be used to augment decisions made by the first wake stage. In response to identifying the designated pattern, the second wake stage may be activated, and the received signal may be provided to the second wake stage.

If it is determined that a second wake stage should be used, method 700 may perform operation 708 during which a wake word may be identified based, at least in part, on frequency modulation at the second wake stage. Accordingly, as similarly discussed above, the second wake stage may be configured to perform narrow-band signal detection using a frequency modulation-based technique. Moreover, a second output signal may be generated based on an output of a component, such as a latch. As discussed above, the second output signal may include an extracted wake code that may have been included in the beacon frame as a data payload.

Method 700 may perform operation 710 during which it may be determined if a valid wake code has been received. In various embodiments, an output of the first wake stage or second wake stage may be selected based on a determination of which wake stage has been used. For example, if the first wake stage was used and the second wake stage was not used, the output of the first wake stage may be selected. If the second wake stage was used, then the output of the second wake stage may be selected.

Once the output of the appropriate wake stage has been selected, the extracted wake code included in the output may be compared against a stored wake code to determine if the correct code has been received and if the code is valid. As similarly discussed above, combinatorial logic may be configured to make such a determination in a power-efficient manner. Moreover, the stored wake code may be a designated code previously stored by an entity, such as a manufacturer or administrator during a configuration process. If the received wake coded matches the stored wake code, it may be determined that a valid wake code has been received.

Method 700 may perform operation 712 during which one or more components of the second wireless device may be transitioned to a wake mode in response to determining that the wake code is valid. Accordingly, as similarly discussed above, a wake signal may be generated that wakes one or more other components of the second wireless device. For example, the wake signal may power up a processor core and processing elements used for wireless communication, such as a Bluetooth stack. It will be appreciated that the wake signal may be used to transition any appropriate power domains from a sleep mode to a wake mode, as may be defined by sleep and wake schemes of the second wireless device.

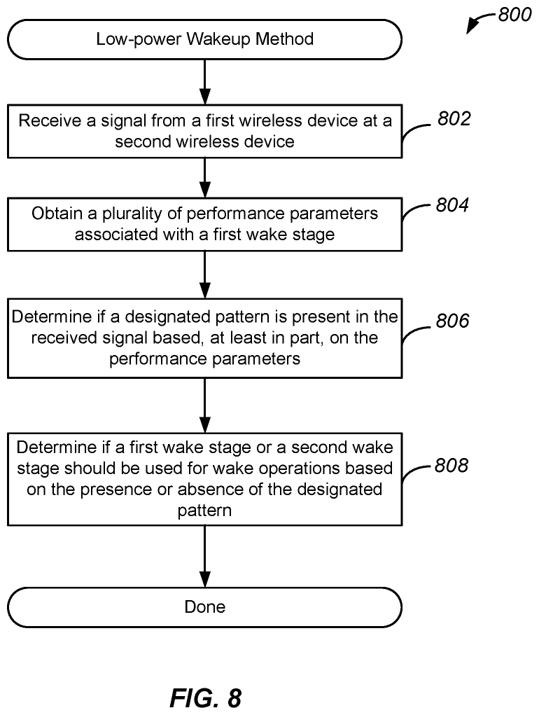

FIG. 8 illustrates flow chart of an additional example of a method for low-power wakeup operations, performed in accordance with some embodiments. As similarly discussed above, processing of a received signal may be split between multiple stages to improve overall power consumption and efficiency of a front-end used for such wake operations. Accordingly, a method, such as method 800, may be performed to obtain performance parameters associated with wake stages, and to determine which wake stage should be used for wakeup operations.

Method 800 may perform operation 802 during which a signal may be received from a first wireless device at a second wireless device. As similarly discussed above, the first wireless device and the second wireless device may communicate in accordance with a wireless communication protocol, such as a Bluetooth protocol. Moreover, the signal may include a beacon frame, and a portion of the beacon frame may be configured to include a wake code.

Method 800 may perform operation 804 during which a plurality of performance parameters associated with a first wake stage may be obtained. In various embodiments, the performance parameters may include performance data associated with the first wake stage, such as previous outputs of a component, such as an envelope detector. As discussed above, such performance data may represent the existence of operational conditions, such as interference. In various embodiments, performance parameters may also include one or more other channel interference and/or signal strength metrics.

Method 800 may perform operation 806 during which it may be determined if a designated pattern is present in the received signal based, at least in part, on the performance parameters. In various embodiments, such a determination may be made based on a comparison of the performance parameters with the designated pattern. As similar discussed above the designated pattern may have been previously defined by an entity, such as a manufacturer. During operation 806, the designated pattern may be compared against the received signal and the performance parameters to determine if there is a match, and if the designated pattern is present.

Method 800 may perform operation 808 during which it may be determined if a first wake stage or a second wake stage should be used for wake operations based on the presence or absence of the designated pattern. Accordingly, as similarly discussed above, if it is determined that the designated pattern is not present, the first wake stage may be used. If it is determined that the designated pattern is present, the second wake stage may be used.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
receiving a signal at a wireless device, the signal comprising a data packet compatible with a wireless communication protocol;
performing, using one or more processing elements, a first wake detection operation at a first wake stage of the wireless device;
determining, based on a designated pattern and performance parameters, if a second wake detection operation should be performed at a second wake stage of the wireless device; and
determining, using one or more processing elements, if a valid wake code has been received based on a designated wake code associated with the data packet.

2. The method of claim 1, wherein the determining if the second wake operation should be performed at a second wake stage further comprises:
determining that the first wake stage is experiencing interference.

3. The method of claim 1, wherein the first wake detection operation comprises:
identifying a first plurality of data values based on envelope detection.

4. The method of claim 3, wherein the second wake detection operation comprises:
identifying a second plurality of data values based on frequency modulation.

5. The method of claim 4, wherein a frequency component of the frequency modulation is determined based on the wireless communication protocol.

6. The method of claim 5, wherein the wireless communication protocol is a Bluetooth Low Energy protocol.

7. The method of claim 1 further comprising:
comparing the data values extracted from the data packet with a designated wake code; and
generating a wake signal in response to the data values matching the designated wake code.

8. The method of claim 7 further comprising:
providing the wake signal to one or more power domains of the wireless device; and
transitioning the one or more power domains from a sleep mode to a wake mode.

9. The method of claim 1, wherein the data packet is a beacon frame.

10. A system comprising:
a transceiver configured to receive a signal comprising a data packet compatible with a wireless communication protocol; and
a processing device configured to:
perform a first wake detection operation at a first wake stage;
determine, based on a designated pattern and performance parameters, if a second wake detection operation should be performed at a second wake stage; and
determine if a valid wake code has been received based on a designated wake code associated with the data packet.

11. The system of claim 10, wherein the determining if the second wake operation should be performed at a second wake stage further comprises:
determining that the first wake stage is experiencing interference.

12. The system of claim 10, wherein the first wake detection operation comprises:
identifying a first plurality of data values based on envelope detection.

13. The system of claim 12, wherein the second wake detection operation comprises:
identifying a second plurality of data values based on frequency modulation.

14. The system of claim 13, wherein a frequency component of the frequency modulation is determined based on the wireless communication protocol.

15. The system of claim 10 wherein the processing device is further configured to:
compare the data values extracted from the data packet with a designated wake code; and
generate a wake signal in response to the data values matching the designated wake code.

16. A device comprising:
one or more processing elements configured to:
receive a signal comprising a data packet compatible with a wireless communication protocol;
perform a first wake detection operation at a first wake stage of a wireless device;
determine, based on a designated pattern and performance parameters, if a second wake detection operation should be performed at a second wake stage of the wireless device; and
determine if a valid wake code has been received based on a designated wake code associated with the data packet.

17. The device of claim 16, wherein the determining if the second wake operation should be performed at a second wake stage further comprises determining that the first wake stage is experiencing interference; and wherein the first wake detection operation comprises identifying a first plurality of data values based on envelope detection.

18. The device of claim 17, wherein the second wake detection operation comprises:
identifying a second plurality of data values based on frequency modulation, and wherein a frequency component of the frequency modulation is determined based on the wireless communication protocol.

19. The device of claim 16, wherein the one or more processing elements are further configured to:
compare the data values extracted from the data packet with a designated wake code; and
generate a wake signal in response to the data values matching the designated wake code.

20. The device of claim 19, wherein the one or more processing elements are further configured to:
provide the wake signal to one or more power domains of the wireless device; and
transition the one or more power domains from a sleep mode to a wake mode.
